(19) United States
(12) Patent Application Publication
(10) Pub. No.: US 2017/0191603 A1
(43) Pub. Date: Jul. 6, 2017

(54) CONNECTING SYSTEMS FOR ADJACENT ENDS OF INSULATION TUBING INCLUDING TABBED SEPARATORS

(71) Applicant: Aeroflex USA, Inc., Sweetwater, TN (US)

(72) Inventors: Brad Steverson, Lenior City, TN (US); Greg Ertel, Clinton, TN (US)

(73) Assignee: Aeroflex USA, Inc., Sweetwater, TN (US)

(21) Appl. No.: 15/467,385

(22) Filed: Mar. 23, 2017

Related U.S. Application Data
(63) Continuation-in-part of application No. 15/174,420, filed on Jun. 6, 2016.
Application No. 15/174,420 is a continuation-in-part of application No. 14/984,533, filed on Dec. 30, 2015.
Application No. 14/984,533 is a continuation-in-part of application No. 13/774,497, filed on Feb. 22, 2013, now abandoned.

(51) Int. Cl. F16L 59/20; B29C 65/50; B29C 65/00; B29C 65/48

(52) U.S. Cl. CPC F16L 59/20; B29C 65/4825; B29C 65/5057; B29C 66/5221; B29C 65/5042; B29L 2023/22

(57) ABSTRACT

An adhesive assembly for joining adjacent ends of insulation tubing, comprising a layer of pressure-sensitive transfer adhesive material, said layer of pressure-sensitive transfer adhesive material capable of bonding to insulation tubing, whereby when said layer of pressure-sensitive transfer adhesive material is positioned between a first section of insulation tubing and a second section of insulation tubing, said layer of pressure-sensitive transfer adhesive material bonds to both the first section of insulation tubing and the second section of insulation tubing; and a disposable release liner including a release liner tab adapted to hold said layer of pressure-sensitive transfer adhesive material prior to positioning said layer of pressure-sensitive transfer adhesive material between the first section of insulation tubing and the second section of insulation tubing. The seam created when the first section of insulation tubing and the second section of insulation tubing are joined may be covered with tape.

### REFERENCE TO RELATED APPLICATIONS

This application is a continuation-in-part of U.S. patent application Ser. No. 15/174,420, filed Jun. 6, 2016, entitled “Connecting Systems for Adjacent Ends of Insulation Tubing”, which is a continuation-in-part of U.S. patent application Ser. No. 14/984,533, filed Dec. 30, 2015, entitled “Connecting Systems for Adjacent Ends of Insulation Tubing”, which is a continuation-in-part of U.S. patent application Ser. No. 13/774,497, filed Feb. 22, 2013, entitled “Connecting Systems for Adjacent Ends of Insulation Tubing”, the entire content of each is incorporated by reference in its entirety.

### BACKGROUND

1. Field of Invention

The present invention relates generally to systems and methods for joining adjacent ends of sections of insulation tubing.

2. Description of the Related Art

Insulation for pipes is known in the art. Insulation tubing is used for pipes and fittings that convey steam, hot materials, condensate, lubricants, cryogenic fluids and cold materials typically used in heating and air conditioning, power facilities, food processing facilities and petrochemical facilities. Thus, insulation tubing is employed in a wide array of industrial applications, such as boilers and petrochemical plants, and for a variety of purposes, including, for example, condensation control and energy conservation (e.g., minimizing thermal leakage).

Insulation tubing generally must be applied in sections. A problem arises of how to ensure a stable connection between two adjacent sections of insulation tubing.

U.S. Pat. No. 6,902,784, issued to Princell et al., discloses a pressure-sensitive adhesive insulation structure for joining two adjacent insulation structures. The pressure-sensitive insulation comprises a carrier having a first side and second side. A pressure-sensitive adhesive is in communication with the first side and in communication with the second side for adhering an insulation structure, such as those used to insulate piping. When used for joining two adjacent insulation structures, the carrier remains in place between the adjacent insulation structures.

When the adhesive transferred to the adjacent ends of the insulation is provided between consecutive release liners, under some conditions, especially lower ambient temperatures, the release liners may be somewhat difficult to remove from the adhesive. There is an ongoing need for release liners that are easier to remove from the interleaved adhesive, especially at low temperature when the user is wearing gloves.

### SUMMARY

In one aspect, the invention provides a method of applying a pressure-sensitive transfer adhesive to connect adjacent ends of insulation tubing. The method includes fitting a first section of insulation tubing to a pipe, the first section of insulation tubing having at least one exposed end; applying a first separation force to a release liner tab of a release liner, where an adhesive assembly includes the release liner and a layer of pressure-sensitive transfer adhesive; separating the adhesive assembly from a stack of adhesive assemblies; attaching the adhesive assembly to the exposed end of the first section of insulation tubing by contacting the layer of pressure-sensitive transfer adhesive with the at least one exposed end of the first section of insulation tubing; applying a second separation force to the release liner tab of the release liner; removing the release liner from the at least one exposed end of the first section of insulation tubing, where the layer of pressure-sensitive transfer adhesive remains adhered to the first section of insulation tubing; fitting a second section of insulation tubing to the pipe; and contacting an exposed end of the second section of insulation tubing with the layer of pressure-sensitive transfer adhesive attached to the first section of insulation tubing, where a ratio of the area of the release liner tab to the area of the release liner is from approximately 1:60 to approximately 1:400.

In another aspect, the invention provides an adhesive assembly, for joining adjacent ends of insulation tubing. The adhesive assembly includes a layer of pressure-sensitive transfer adhesive material formulated to bond to exposed ends of insulation tubing, where when said layer of pressure-sensitive transfer adhesive material is positioned between the exposed ends of a first section of insulation tubing and a second section of insulation tubing, the layer of pressure-sensitive transfer adhesive bonds to both the exposed end of the first section of insulation tubing and the exposed end of the second section of insulation tubing; and a release liner including a release liner tab, the disposable release liner configured to adhere the layer of pressure-sensitive transfer adhesive with less force than the layer of pressure-sensitive transfer adhesive adheres the exposed end of the first section of insulation tubing, where a ratio of the area of the release liner tab to the area of the release liner is from approximately 1:60 to approximately 1:400.

The scope of the present invention is defined solely by the appended claims and is not affected by the statements within this summary. Other methods, features, and advantages of the invention will be, or will become, apparent to one with skill in the art upon examination of the following figures and description.

### DESCRIPTION OF THE SEVERAL VIEWS OF THE DRAWINGS

The above-mentioned and additional features of the invention will become more clearly understood from the following detailed description of the invention read together with the drawings in which:

FIG. 1 is an exploded view of a laminar body including a plurality of sheets of release liner material coated with layers of pressure-sensitive transfer adhesive material;

FIG. 2 is a perspective view of the laminar body shown in FIG. 1, showing stacks of release liners including tabs and layers of pressure-sensitive transfer adhesive material being cut from the laminar body;

FIG. 3 is a perspective view of a stack of release liners including tabs and layers of pressure-sensitive transfer adhesive material;

FIG. 4A is a view of one part of the process of applying a layers of pressure-sensitive transfer adhesive material according to the present general inventive concept, showing the detachment of one release liner including tabs and an attached layer of pressure-sensitive transfer adhesive material from the stack;

FIG. 4B is a view of another part of the process of applying a layer of pressure-sensitive transfer adhesive material according to the present general inventive concept, showing the orientation of the release liner including tabs proximate a section of insulation tubing;

FIG. 4C is a view of one part of the process of applying a layer of pressure-sensitive transfer adhesive material according to the present general inventive concept, showing the release liner being peeled away from the section of insulation tubing by the release liner tab, leaving the layer of pressure-sensitive transfer adhesive material on the section of insulation tubing;

FIG. 4D is a view of one part of the process of applying a layer of pressure-sensitive transfer adhesive material according to the present general inventive concept, showing the joinder of two sections of insulation tubing with the layer of pressure-sensitive transfer adhesive material between them;

FIG. 5A is a perspective view of a disposable release liner including a release liner tab and attached layer of pressure-sensitive transfer adhesive material;

FIG. 5B is a perspective view of a disposable release liner including a release liner tab and attached layer of pressure-sensitive transfer adhesive material with scrim;

FIG. 6A is a perspective view of an example embodiment of an adhesive assembly including a disposable release liner including a release liner tab and a layer of pressure-sensitive transfer adhesive material, showing the adhesive assembly being positioned on a pipe;

FIG. 6B is another perspective view of the example embodiment shown in FIG. 6A, showing the adhesive assembly pressed against the exposed end of a section of insulation tubing on a pipe;

FIG. 6C is another perspective view of the example embodiment shown in FIGS. 6A and 6B, showing the pressure-sensitive transfer adhesive material on the section of insulation tubing on a pipe after the release liner has been removed;

FIG. 7A is a view of an example embodiment process of applying an adhesive assembly to a section of insulation tubing on a pipe;

FIG. 7B is a view of another portion of the process shown in FIG. 7A, showing the installation of a second section of insulation tubing;

FIG. 7C is a view of another portion of the process shown in FIGS. 7A and 7B, showing the joining of the first and second sections of insulation tubing and the covering of the sections with tape;

FIG. 8A is a perspective view of a further example embodiment of an adhesive assembly including a disposable release liner including a release liner tab and a layer of pressure-sensitive transfer adhesive material, showing the adhesive assembly being positioned on a pipe;

FIG. 8B is another perspective view of the example embodiment shown in FIG. 8A, showing the adhesive assembly pressed against the exposed end of a section of insulation tubing on a pipe; and

FIG. 8C is another perspective view of the example embodiment shown in FIGS. 8A and 8B, showing the pressure-sensitive transfer adhesive material on the section of insulation tubing on a pipe after the release liner has been removed.

FIG. 9 is a representation of a disposable release liner having a generally rectangular release liner tab and an attached layer of pressure-sensitive transfer adhesive material.

### DETAILED DESCRIPTION

Stacked adhesive assembly systems and methods of making stacked adhesive assemblies for readily joining or connecting adjacent ends of sections of insulation tubing are described. Each of the stacked adhesive assemblies includes a release liner having a central opening and a tab. A layer of pressure-sensitive transfer adhesive material is attached to each side of the release liner, such that one side of the layer of pressure-sensitive transfer adhesive material is able to bond to an end face of one section of insulation tubing, and the other side of the layer of pressure-sensitive transfer adhesive material is able to bond to an end face of the second section of insulation tubing when the release liner is removed by applying a separation force to the tab.

An adhesive assembly for joining adjacent ends of insulation tubing encompasses a layer of pressure-sensitive transfer adhesive material, said layer of pressure-sensitive transfer adhesive material capable of bonding to insulation tubing, whereby when said layer of pressure-sensitive transfer adhesive material is positioned between a first section of insulation tubing and a second section of insulation tubing, said layer of pressure-sensitive transfer adhesive material bonds to both the first section of insulation tubing and the second section of insulation tubing; and a disposable release liner including a release liner tab adapted to hold said layer of pressure-sensitive transfer adhesive material prior to positioning said layer of pressure-sensitive transfer adhesive material between the first section of insulation tubing and the second section of insulation tubing. The seam created when the first section of insulation tubing and the second section of insulation tubing are joined may be covered with tape.

The adhesive assembly includes a layer of viscous, pressure-sensitive adhesive (hereinafter generally “pressure-sensitive transfer adhesive”) to position between adjacent ends of neighboring pieces of insulation tubing. In some embodiments, the layer of pressure-sensitive transfer adhesive includes a scrim that acts as a reinforcing structure to keep the layer of pressure-sensitive transfer adhesive material intact as a single body during and after application between two adjacent sections of insulation tubing.

The release liner tab of each of the release liners facilitates the removal of one release liner from one of the two pressure sensitive transfer adhesive layers in contact with the release liner when an adhesive assembly is being removed from the stack of adhesive assemblies. The release liner tab also facilitates removal of the release liner from the pressure sensitive transfer adhesive layer bonded to an end of the insulation tubing. In both instances, a separation force is applied, generally by a user holding the release liner tab with his fingers and pulling in a direction opposite the pressure sensitive transfer adhesive layer intended to remain in place. This direction is generally “up” when the adhesive assembly is being removed from the stack of adhesive assemblies and generally “horizontal” when the release liner is being removed from the pressure sensitive transfer adhesive layer adhered to the insulation. The separation force applied is sufficient to remove the adhesive assembly or release liner from the underlying pressure sensitive transfer adhesive layer and varies based on the diameter of the adhesive assembly, ambient temperature, and the like.

The ratio of the area and length of the release liner tab in relation to the area and radius, respectively, of the circular portion of the release liner is important in the release liner tab remaining attached to the release liner when the separation force is applied—as the tearing off of the release liner tab with the release liner remaining adhered to the pressure sensitive transfer adhesive layer is undesirable. The measurements of these areas and dimensions will change with different diameters of adhesive assemblies.

For example with regard to area ratios, if the area of the release liner is 47 cm² and the area of the release liner tab is 0.6 centimeters squared (cm²), the ratio of the release liner tab to the release liner is 1:78. Preferably, the area of the release liner remains about the same regardless of the area of the release liner, as once the proper area of the release liner tab is reached to not tear when the separation force is applied, the area of the release liner tab does not have to increase with increases in the area of the release liner. A preferable range of release liner tab to release liner area ratios is from a minimum of about 1:60 to a maximum of about 1:400. Thus, while the ratio should not drop below about 1:60, the area of the release liner in relation to the area of the release liner tab can increase substantially.

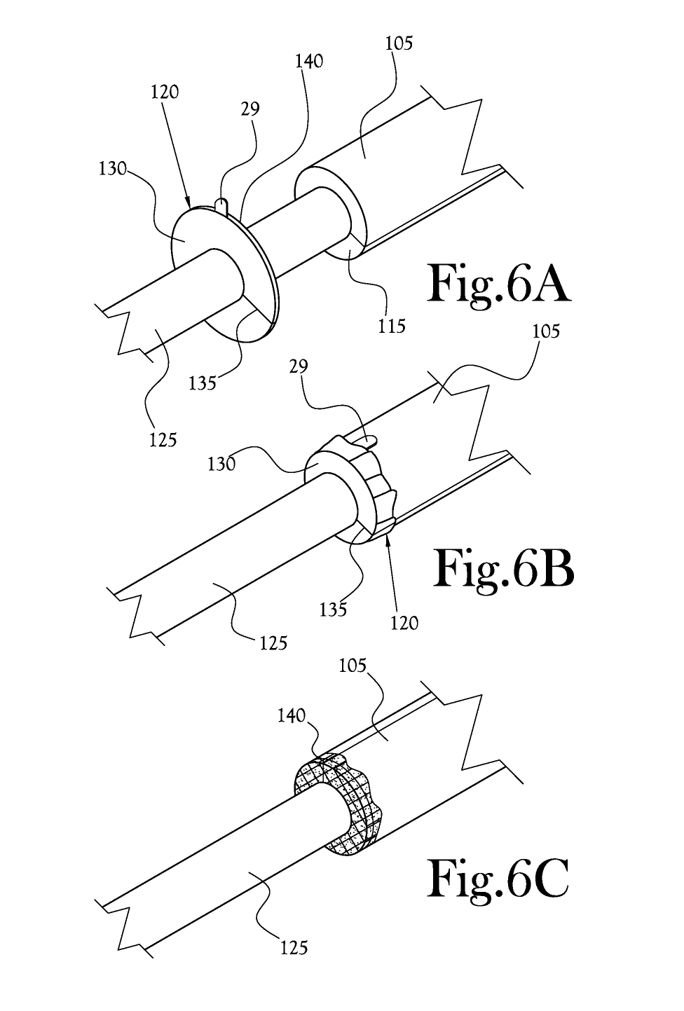

Similarly, with regard to length ratios, if the length the release liner tab extends outward from the outer circumference of the release liner is 8 millimeters (mm) (Shown as “T” in FIG. 5A) and the radius of the outer circumference of the release liner is 29 mm (Shown as “L” in FIG. 5A), the ratio of the length of the release liner tab to the radius of the outer circumference of the release liner is 1:3.7. Preferably, the length of the release liner tab remains about the same regardless of the radius of the outer circumference of the release liner, as once the proper length of the release liner tab is reached to not tear when the separation force is applied, the length of the release liner tab does not have to increase with increases in the outer circumference of the release liner. A preferable range of release liner tab length to release liner outer circumference radius from a minimum of approximately 1:2 to a maximum of approximately 1:16. Thus, while the ratio should not drop below about 1:2, the radius of the outer circumference of the release liner can increase substantially.

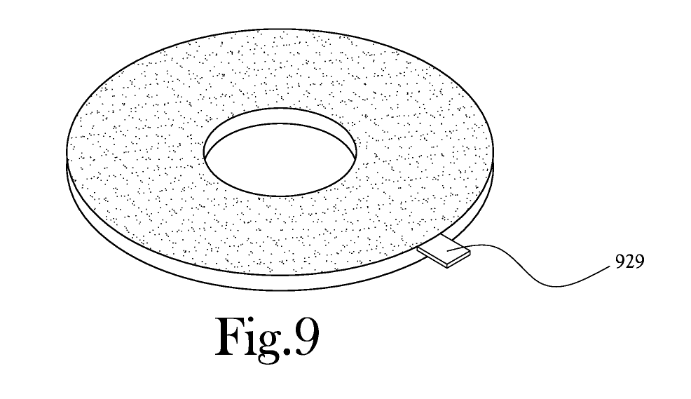

While the figures represent the tangential protrusion angle of the release liner tab at approximately 90° in relation to the outer circumference of the release liner, other tangential protrusion angles may be used for the release liner tab. The release liner tab may be rounded, rectangular, or another shape that is consistent with peeling of the release liner. For example, FIG. 5A represents the release liner tab 29 as rounded, while FIG. 9 represents release liner tab 929 as generally rectangular. Regardless of the general shape of the release liner tab, the preferred area and length ratios remain the same. The release liner tab may be formed from the release liner material or a separate part adhered, fused, and the like to the release liner.

An adhesive assembly or adhesive assembly for joining adjacent ends of insulation tubing may include a layer of pressure-sensitive transfer adhesive material, said layer of pressure-sensitive transfer adhesive material formulated to bond to insulation tubing, whereby when said layer of pressure-sensitive transfer adhesive material is positioned between a first section of insulation tubing and a second section of insulation tubing, said layer of pressure-sensitive transfer adhesive material bonds to both the first section of insulation tubing and the second section of insulation tubing; and a disposable release liner adapted to hold said layer of pressure-sensitive transfer adhesive material prior to positioning said layer of pressure-sensitive transfer adhesive material between the first section of insulation tubing and the second section of insulation tubing.

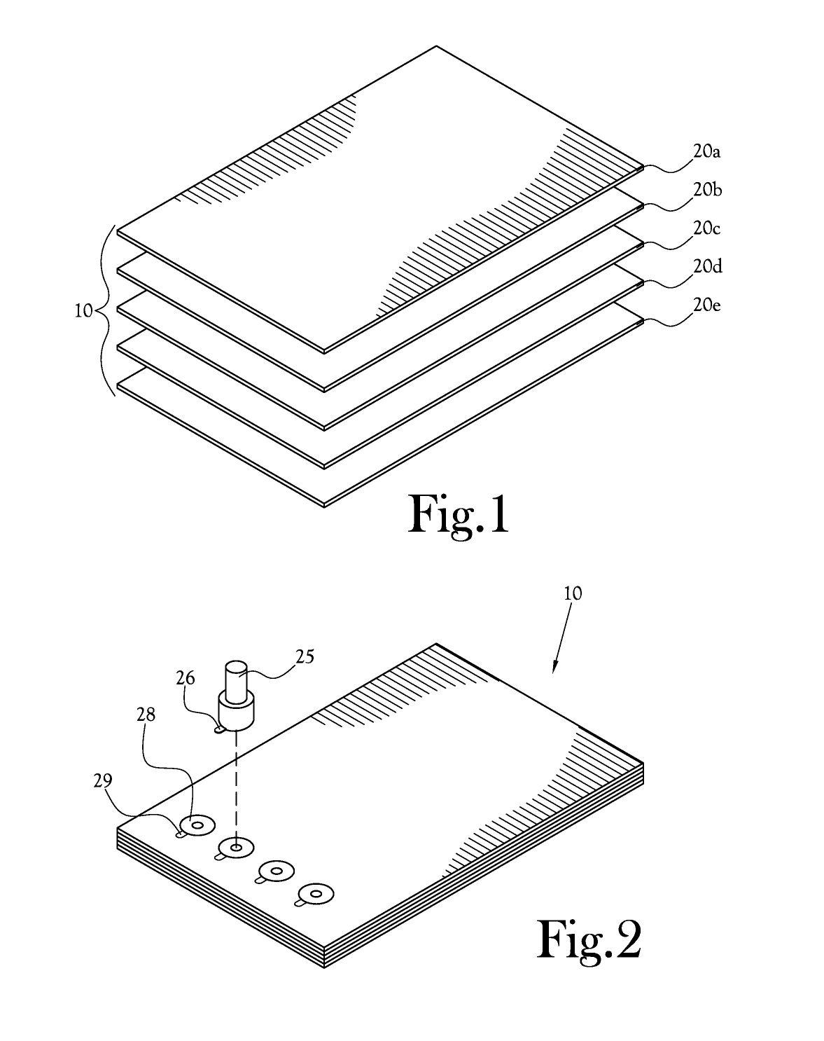

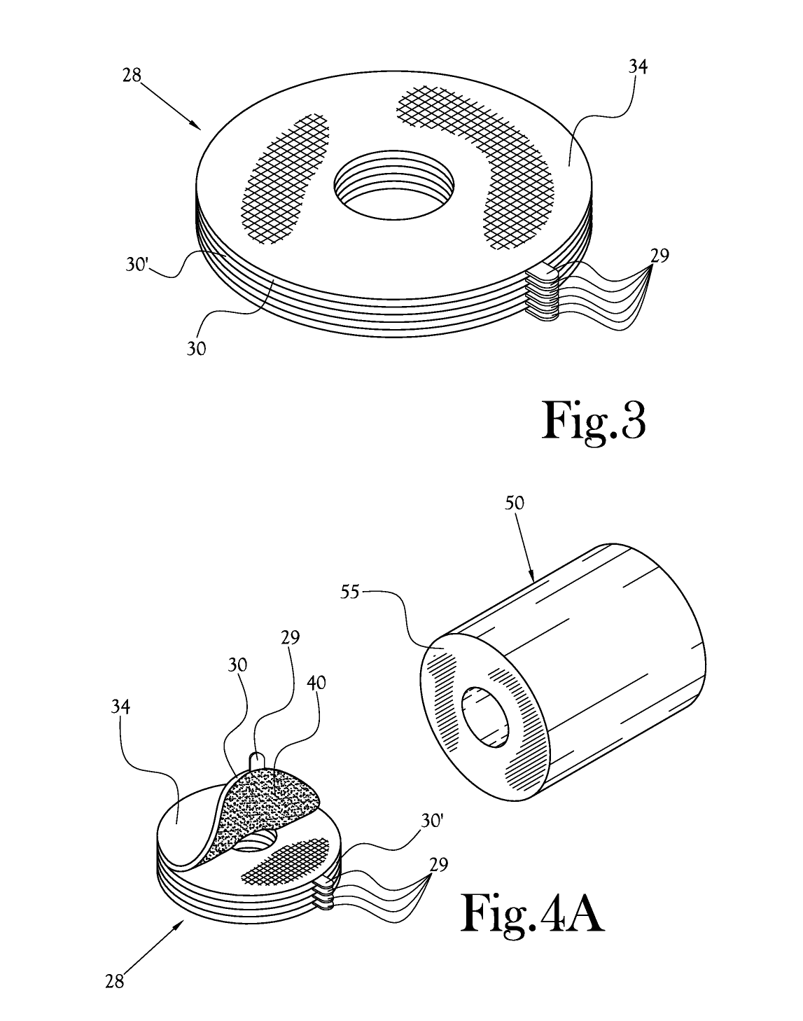

FIG. 1 shows an exploded view of a laminate body involved in the manufacture of a stack of release liners according to one example embodiment of the present general inventive concept. As shown in FIG. 1, the laminate body 10 includes a plurality of sheet layers 20a-e of release liner material. Generally, a layer of pressure-sensitive transfer adhesive material is interposed between each sheet layer 20a-e, resulting in a laminar body 10 shown in FIG. 2.

In FIG. 2, in a subsequent phase of the manufacturing process, a punch 25 including a release liner tab cutter 26 is used to carve from the laminar body a stack 28 of substantially disc-like release liners including release liner tabs 29 with pressure-sensitive transfer adhesive material between each release liner.

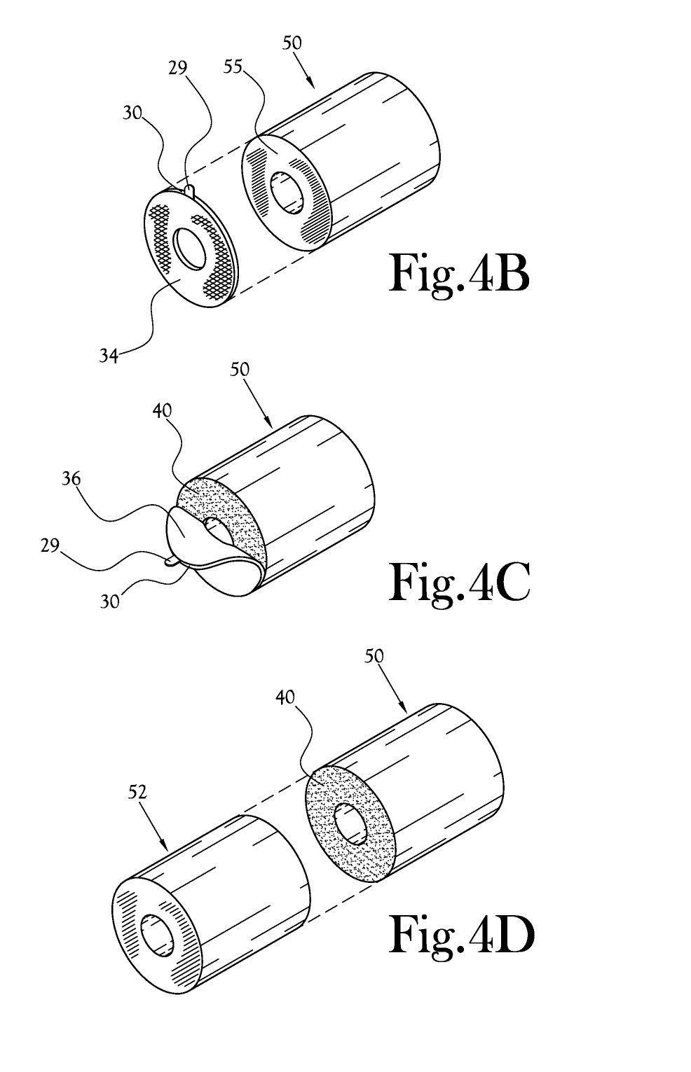

FIG. 3 illustrates one example embodiment of a stack 28 of release liners, each release liner having a central opening and a tab; as a result of the manufacturing process, pressure-sensitive transfer adhesive material is positioned between each release liner (for example, between the top-most release liner 30 and the next release liner 30′ in the illustrated example embodiment). FIG. 3 further indicates an outboard or top-facing surface 34 of the top-most release liner 30; generally, this outboard surface 34 is free of pressure-sensitive transfer adhesive material.

Although the Figures indicated above illustrate one example embodiment of a fabrication process for producing a laminate body according to the present general inventive concept, other fabrication processes and methods are contemplated and are encompassed by the present general inventive concept. The illustrated example embodiment shown in FIGS. 1-2 is not intended to be limiting, and should not be read as such.

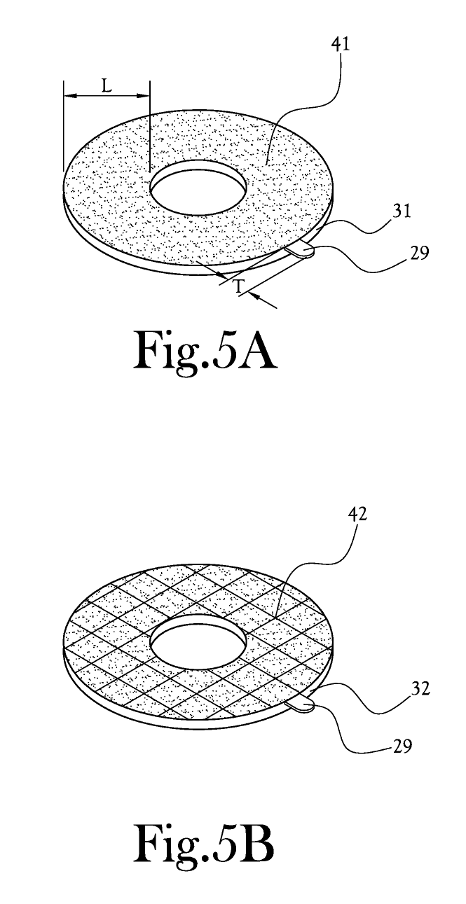

FIGS. 4A through 4D illustrate one example embodiment of a method of using a release liner with pressure-sensitive transfer adhesive material to apply pressure-sensitive transfer adhesive material to a section of insulation tubing. The illustrated example embodiment method also demonstrates some of the advantages of the present general inventive concept. As shown in FIG. 4A, the top-most or first release liner 30 of the stack 28 is peeled away from the second release liner 30′ immediately below the first release liner 30 by applying a separation force to the release liner tab 29. When the first release liner 30 is peeled away from the stack 28, a layer of pressure-sensitive transfer adhesive material 40 remains attached to the first release liner 30; previous to the peeling away of the first release liner 30 from the stack 28, the layer of pressure-sensitive transfer adhesive material 40 resided between the first release liner 30 and the second release liner 30′. Once the first release liner 30 has been fully detached from the stack 28, the first release liner 30 is moved into position near a section of insulation tubing 50, as shown in FIG. 4B. The section of insulation tubing 50 includes an end face 55, where the layer of pressure-sensitive transfer adhesive material 40 is to be applied. As shown in FIG. 4C, the first release liner 30 is abutted to the end face 55 of the section of insulation tubing 55, such that the layer of pressure-sensitive transfer adhesive material 40 substantially covers and is in physical contact with the end face 55. The first release liner 30 is then moved away from the end face 55 of the section of insulation tubing 50 by applying a separation force to the release liner tab 29, while the layer of pressure-sensitive transfer adhesive material 40 remains deposited on the end face 55 of the section of insulation tubing 50. Next, as shown in FIG. 4D, a second section of insulation tubing 52 is moved into a position such that an end face of the second section of insulation tubing 52 is directly opposing and substantially adjacent to the end face 55 of the first section of insulation tubing 50, with the layer of pressure-sensitive transfer adhesive material 40 between the two end faces. The layer of pressure-sensitive transfer adhesive material 40 thereby adheres to the two proximate end faces of both sections of insulation tubing 50 and 52.

Thus, in the illustrated example embodiment, and in other example embodiments of the present general inventive concept, a stack of release liners, with inter-release liner layers of pressure-sensitive transfer adhesive material, facilitates the speedy and efficient application of layers of pressure-sensitive transfer adhesive material to join adjacent sections of insulation tubing. As each release liner is removed from the stack by applying a separation force to the release liner tab of the release liner, said release liner transports with it a layer of pressure-sensitive transfer adhesive material, which is applied between two adjacent sections of insulation tubing. The next release liner in the stack is then ready to be removed from the stack, and the process of applying the layer of pressure-sensitive transfer adhesive material between two adjacent sections of insulation tubing is repeated. The stack configuration facilitates the quick application of pressure-sensitive transfer adhesive material. In various embodiments, release liners may be peeled from the top of the stack or from the bottom of the stack by applying a separation force to the release liner tab of the respective release liner.

In some example embodiments of the present general inventive concept, such as that shown in FIG. 5A, the release liner 31 includes a layer of pressure-sensitive transfer adhesive material 41 that includes no scrim or reinforcing structure within the layer of pressure-sensitive transfer adhesive material 41 itself. In some example embodiments, such as that shown in FIG. 5B, the release liner 32 is connected to a layer of pressure-sensitive transfer adhesive material 42 that does include a scrim or other reinforcing structure within the layer of pressure-sensitive transfer adhesive material 42 itself. In these embodiments, the scrim or reinforcing structure generally comprises a fine, lightweight material worked in a crisscrossed pattern and in close contact with or surrounded by the pressure-sensitive transfer adhesive material. Generally, the crisscrossed pattern of the scrim leaves substantial apertures allowing the free through-penetration of pressure-sensitive transfer adhesive material, while still performing a reinforcing function and helping to keep the pressure-sensitive transfer adhesive material together in a single body.

In some embodiments, the pressure-sensitive transfer adhesive material is an acrylic-based pressure-sensitive transfer adhesive. In some embodiments, the pressure-sensitive transfer adhesive material is a rubber-based pressure-sensitive transfer adhesive. Those of skill in the art will recognize that other pressure-sensitive transfer adhesive materials will be suitable, and that the present general inventive concept is not limited to any particular pressure-sensitive transfer adhesive material or any single class of pressure-sensitive transfer adhesive materials.

Thus, some embodiments of the present general inventive concept include an adhesive assembly to join adjacent ends of insulation tubing, comprising a release liner coated with a layer of pressure-sensitive transfer adhesive material, said release liner having a central opening and a release liner tab at the periphery of the release liner. Said release liner transports with itself a layer of pressure-sensitive transfer adhesive material, said layer of pressure-sensitive transfer adhesive material to bond to insulation tubing. When said layer of pressure-sensitive transfer adhesive material is positioned between a first section of insulation tubing and a second section of insulation tubing, one side of said layer of pressure-sensitive transfer adhesive material bonds to the first section of insulation tubing and another side of said layer of pressure-sensitive transfer adhesive material bonds to the second section of insulation tubing.

In several embodiments, the release liner can include a split extending from the center opening to the outer edge. In some embodiments, said layer of pressure-sensitive transfer adhesive material includes a scrim to reinforce the layer of pressure-sensitive transfer adhesive material. In some embodiments, said layer of pressure-sensitive transfer adhesive material includes an acrylic-based pressure-sensitive transfer adhesive material. In some embodiments, said layer of pressure-sensitive transfer adhesive material includes a rubber-based pressure-sensitive transfer adhesive material. The present general inventive concept is not limited to any particular adhesive material or any single class of adhesive materials, and other pressure-sensitive transfer adhesive materials may be suitable in some embodiments.

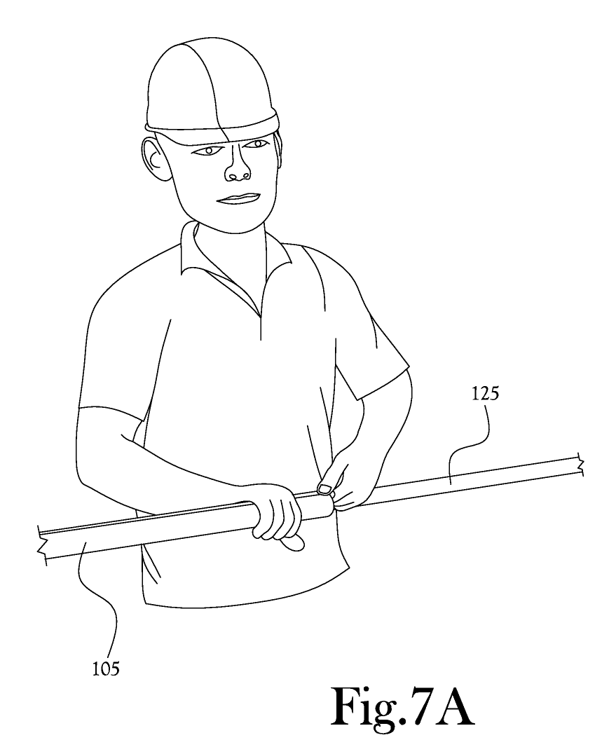

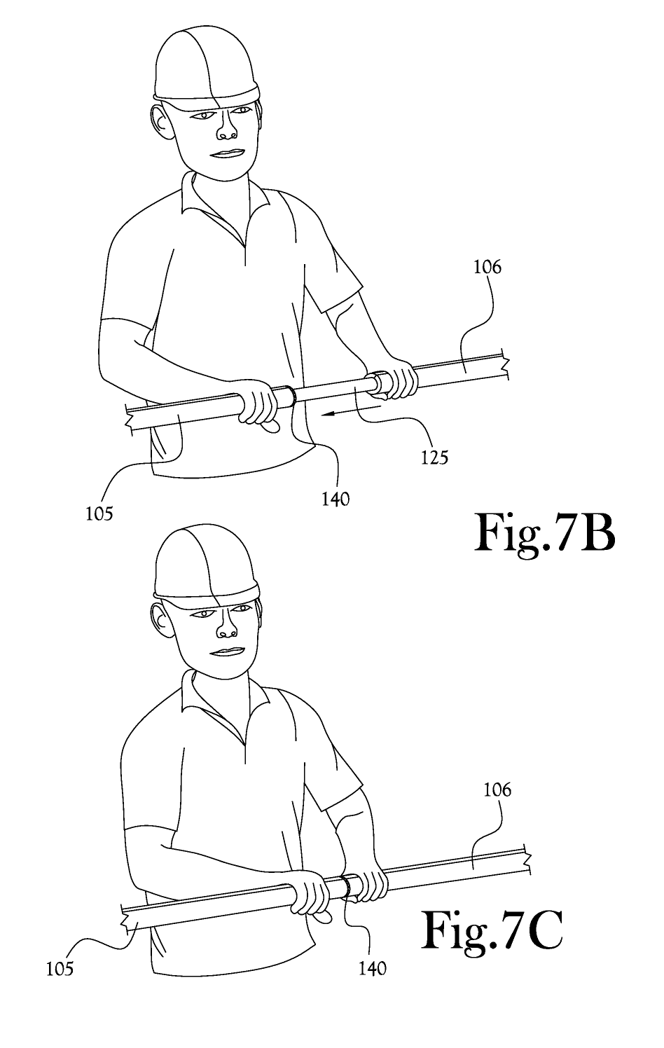

FIGS. 6A through 7C illustrate a further example embodiment of a sealing system 100 for joining two units of insulation tubing. As shown in FIG. 6A, a first section or piece of insulation tubing 105 is fitted around a length of pipe 125. An adhesive assembly 120 comprising a release liner 130 and a release liner tab 29 and a layer of pressure-sensitive adhesive material 140 is positioned on the pipe 125 proximate an exposed end 115 of the insulation tubing 105; to this end, a split 135 in the adhesive assembly 120, extending from the center opening of the adhesive assembly 120 to the outer edge adhesive assembly 120, facilitates the positioning of the adhesive assembly 120 on the pipe 125, such that the adhesive assembly 120 substantially wraps around the circumference of the pipe 125. The adhesive assembly 120 is aligned with the insulation tubing 105, using the pipe 125 as a guide, and the adhesive assembly 120 is pressed against the exposed end 115 of the insulation tubing 105, as shown in FIG. 6B and in FIG. 7A, so that the layer of pressure-sensitive adhesive material 140 makes contact with the exposed end 115 of the insulation tubing 105. The release liner 130 is then pulled away from the insulation tubing 105 by applying a separation force to the release liner tab 29, leaving only the layer of pressure-sensitive adhesive material 140 in place, as shown in FIG. 6C.

Next, as shown in FIGS. 7B and 7C, a second piece of insulation tubing 106 is fitted around the pipe 125, and the second piece of insulation tubing 106 is moved and brought into contact with the layer of pressure-sensitive adhesive material 140 already affixed to the first piece of insulation tubing 105. In this way, the first piece of insulation tubing 105 and the second piece of insulation tubing 106 are joined, with the layer of pressure-sensitive adhesive material 140 between them and adhering to both pieces of insulation tubing.

In some embodiments, the outer diameter of the adhesive assembly 120 is greater than the outer diameter of the insulation tubing 105; in such cases, the excess portion of the adhesive assembly 120 is folded over the outbound surface of the insulation tubing 105, as shown in FIG. 6B; this leaves excess pressure-sensitive adhesive material 140 on the outbound surface of the insulation tubing 105, as shown in FIG. 6C. In such cases, after the first piece of insulation tubing 105 and the second piece of insulation tubing 106 are joined, tape may be applied around the seam where the two pieces of insulation tubing meet (not shown). The tape may cover any excess pressure-sensitive adhesive material 140. Generally, the tape may be at least two inches wide.

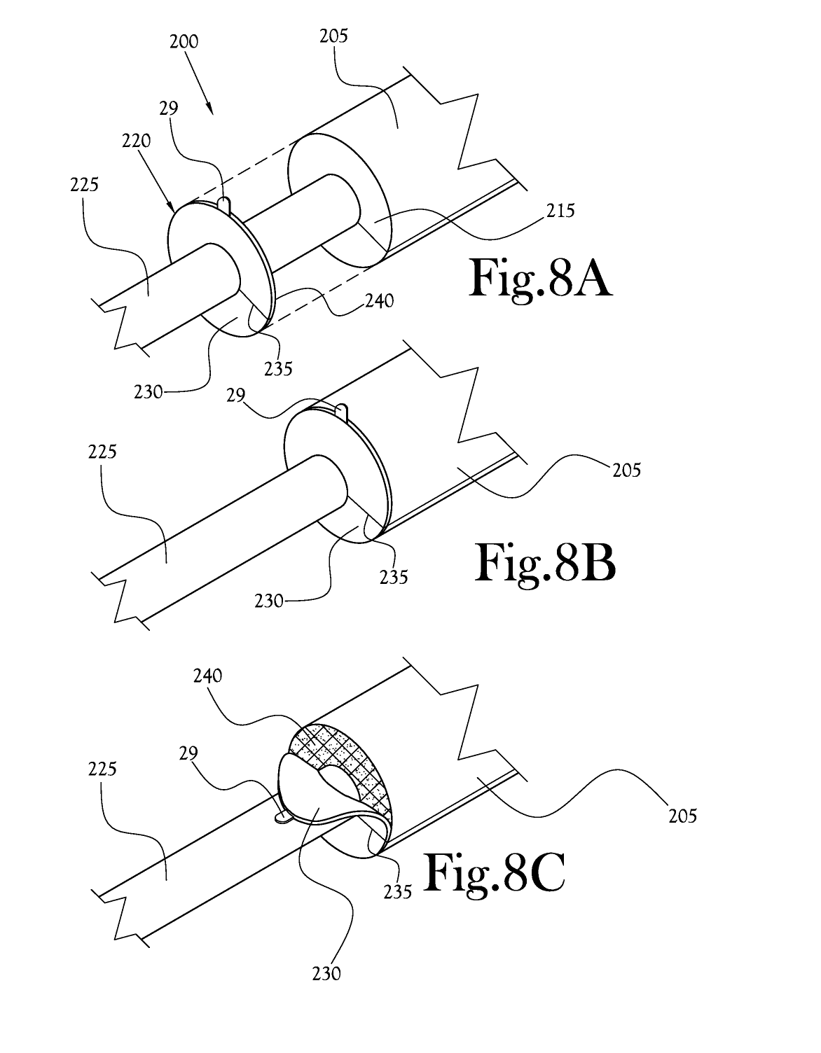

FIGS. 6A through 6C illustrate an example embodiment in which the outer diameter of the adhesive assembly 120 is greater than the outer diameter of the insulation tubing 105. It is also possible, in some example embodiments, to have an adhesive assembly 220 in which the outer diameter of the adhesive assembly 220 is substantially the same as the outer diameter of the insulation tubing 205; one such example embodiment is shown in FIGS. 8A through 8C. The application and use of this example embodiment system 200 is substantially similar to the application and use of the system 100 shown in FIGS. 7A through 7C.

In FIGS. 8A through 8C an adhesive assembly 220 comprising a release liner 230 including a release liner tab 29 and a layer of pressure-sensitive adhesive material 240 is positioned on the pipe 225 proximate an exposed end 215 of the insulation tubing 205; to this end, a split 235 in the adhesive assembly 220, extending from the center opening of the adhesive assembly 220 to the outer edge adhesive assembly 220, facilitates the positioning of the adhesive assembly 220 on the pipe 225, such that the adhesive assembly 220 substantially wraps around the circumference of the pipe 225. The adhesive assembly 220 is aligned with the insulation tubing 205, using the pipe 225 as a guide, and the adhesive assembly 220 is pressed against the exposed end 215 of the insulation tubing 205, as shown in FIG. 8B. The release liner 230 is pulled away from the insulation tubing 205, leaving the layer of pressure-sensitive adhesive material 240 in place, as shown in FIG. 8C. Next, a second piece of insulation tubing is fitted around the pipe, and the second piece of insulation tubing is moved and brought into contact with the layer of pressure-sensitive adhesive material 240 already affixed to the first piece of insulation tubing 205. In this way, the first piece of insulation tubing and the second piece of insulation tubing are joined, with the layer of pressure-sensitive adhesive material between them and adhering to both pieces of insulation tubing. Tape also may be applied around the seam where the two pieces of insulation tubing meet, although there is substantially no adhesive material on the outboard surface of the insulation tubing.

In FIG. 8A and in FIG. 8B the positional orientation of the release liner tab 29 in relation to the split 235 is represented as approximately 90 degrees of separation. Preferably, however the tab 29 and the split 235 may be closer. Preferably, degrees of separation are from 10 to 90 degrees, with a separation of 50 degrees to 80 degrees being more preferred. This separation between the release liner tab 29 and the split 235 reduces the likelihood that the release liner tab 29 will tear from the release liner when a separation force is applied.

In some embodiments, the components of the adhesive assembly, along with other tools and/or materials to apply and use the adhesive assembly, are provided in a kit or carton. In one such example embodiment, inside the kit or carton is a tape squeegee and a single stack of adhesive assemblies sized for the internal diameter and wall thickness of the insulation tubing at hand. Generally, the stack of adhesive assemblies is mounted on a thin non-adhesive disc that allows a user to hold the stack in hand or conveniently keep it in pocket. To complete the installation, a tape measure, a knife, a pair of scissors, a tape applicator tool or tape squeegee, a sharpening stone and appropriate safety equipment are sometimes requires. Tape is a component of this closure system.

To start, a section of insulation tubing is applies to a pipe. Next, an adhesive assembly is removed from the stack by applying a separation force to the release liner tab of the associated release liner; the adhesive assembly then peels from the stack similarly to a sticky note. A user opens the factory-made split in the adhesive assembly and then slips the adhesive assembly over the piping. Using the pipe as a guide, the user properly aligns the adhesive assembly with the insulation and then presses the exposed adhesive side of the adhesive assembly to the installed insulation. (Generally, each adhesive assembly is designed to work with at least two thicknesses of insulation.) When using the adhesive assembly with a thinner wall pipe, it is normal to have some excess adhesive around the outside diameter of the insulation sections; a user simply folds the excess adhesive onto the outside diameter of the pipe insulation before continuing.

The next section of insulation tubing is installed over the pipe. Then, the release liner is removed from the exposed side of the adhesive assembly by applying a separation force to the release liner tab of the release liner, and then the next section of insulation tubing is pressed against the adhesive material with sufficient pressure to make a bond between the adhesive and both sections of insulation tubing. The insulation should be installed with a slight amount of compression at each joint to insure a proper seal. The insulation is allowed it to relax before installation of tape over the seam. To install the tape, a user determines the total outside diameter of the pipe insulation being applied and then measures and cuts a strip of tape to length, generally adding a minimum of two inches to provide adequate overlap. The user applies the strip of tape around the circumferential butt seam on the top of the adhesive material. Generally, the tape is placed so that the width is evenly divided across both sides of the butt joint.

In various example embodiments, the present general inventive concept provides a method of bonding two insulation sleeves that is simpler compared to methods and assemblies known in the art. Compared to previous options, example embodiments of the present general inventive are thinner—that is, there is only the layer of pressure-sensitive transfer adhesive remaining between the sleeves once fully applied. This thinness eliminates need for additional insulation by eliminating gaps between the insulation sleeves that are being bonded.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of applying a pressure-sensitive transfer adhesive to connect adjacent ends of insulation tubing, the method comprising:
fitting a first section of insulation tubing to a pipe, the first section of insulation tubing having at least one exposed end;
applying a first separation force to a release liner tab of a release liner, where an adhesive assembly includes the release liner and a layer of pressure-sensitive transfer adhesive;
separating the adhesive assembly from a stack of adhesive assemblies;
attaching the adhesive assembly to the exposed end of the first section of insulation tubing by contacting the layer of pressure-sensitive transfer adhesive with the at least one exposed end of the first section of insulation tubing;
applying a second separation force to the release liner tab of the release liner;
removing the release liner from the at least one exposed end of the first section of insulation tubing, where the layer of pressure-sensitive transfer adhesive remains adhered to the first section of insulation tubing;
fitting a second section of insulation tubing to the pipe; and
contacting an exposed end of the second section of insulation tubing with the layer of pressure-sensitive transfer adhesive attached to the first section of insulation tubing, where
a ratio of the area of the release liner tab to the area of the release liner is from approximately 1:60 to approximately 1:400.

2. The method of claim 1, where the removing the release liner from the at least one exposed end of the first section of insulation includes removing the release liner from around the pipe by passing the pipe through a split in the release liner.

3. The method of claim 1, where the layer of pressure-sensitive transfer adhesive includes a scrim to reinforce the layer of pressure-sensitive transfer adhesive.

4. The method of claim 1, where the layer of pressure-sensitive transfer adhesive includes an acrylic-based pressure-sensitive transfer adhesive.

5. The method of claim 1, where the layer of pressure-sensitive transfer adhesive includes a rubber-based pressure-sensitive transfer adhesive.

6. The method of claim 1, further comprising:
forming a seam where the first section of insulation tubing is proximate the second section of insulating tubing; and
covering the seam with tape.

7. The method of claim 1, where the ratio of the length of the release liner tab to the radius of the outer circumference of the release liner is from approximately 1:2 to approximately 1:16.

8. The method of claim 1, where the release liner is disposable.

9. (B) An adhesive assembly, for joining adjacent ends of insulation tubing, the adhesive assembly comprising:
a layer of pressure-sensitive transfer adhesive material formulated to bond to exposed ends of insulation tubing,
where when said layer of pressure-sensitive transfer adhesive material is positioned between the exposed ends of a first section of insulation tubing and a second section of insulation tubing, the layer of pressure-sensitive transfer adhesive bonds to both the exposed end of the first section of insulation tubing and the exposed end of the second section of insulation tubing; and
a release liner including a release liner tab, the disposable release liner configured to adhere the layer of pressure-sensitive transfer adhesive with less force than the layer of pressure-sensitive transfer adhesive adheres the exposed end of the first section of insulation tubing, where
a ratio of the area of the release liner tab to the area of the release liner is from approximately 1:60 to approximately 1:400.

10. The adhesive assembly of claim (b), where the release liner includes a split separated from 10 to 90 degrees from the release liner tab.

11. The adhesive assembly of claim (b), where the release liner includes a split separated from 50 to 80 degrees from the release liner tab.

12. The adhesive assembly of claim (b), where the layer of pressure-sensitive transfer adhesive includes a scrim reinforcing the layer of pressure-sensitive transfer adhesive.

13. The adhesive assembly of claim (b), where the layer of pressure-sensitive transfer adhesive includes an acrylic-based pressure-sensitive transfer adhesive.

14. The adhesive assembly of claim (b), where the layer of pressure-sensitive transfer adhesive material includes a rubber-based pressure-sensitive transfer adhesive.

15. The adhesive assembly of claim (b), further comprising a length of tape to cover a seam created when the layer of pressure-sensitive transfer adhesive adheres the first and the second sections of insulation tubing.

16. The adhesive assembly of claim (b), where the ratio of the length of the release liner tab to the radius of the outer circumference of the release liner is from approximately 1:2 to approximately 1:16.

17. The adhesive assembly of claim (b), where the release liner is disposable.
